(19) United States
(12) Patent Application Publication
(10) Pub. No.: US 2025/0211400 A1
(43) Pub. Date: Jun. 26, 2025

(54) SYSTEMS AND METHODS FOR BEAM ALIGNMENT WITH DUAL-POLARIZED ANTENNAS

(71) Applicant: Huawei Technologies Co., Ltd., Shenzhen (CN)

(72) Inventors: Wen Tong, Ottawa (CA); Xi Zhang, Ottawa (CA); Xiaoyan Bi, Shanghai (CN); Jianglei Ma, Ottawa (CA)

(21) Appl. No.: 19/053,103

(22) Filed: Feb. 13, 2025

Related U.S. Application Data
(63) Continuation of application No. PCT/CN2022/112501, filed on Aug. 15, 2022.

(51) Int. Cl. H04L 5/00; H01Q 1/24

(52) U.S. Cl. CPC H04L 5/0058; H01Q 1/246

(57) ABSTRACT

In some embodiments, dual-polarized antennas may be implemented by establishing a mapping relation between synchronization signals and polarization directions of polarized antennas at the base station or polarization directions in relation to a reference plane. Examples of synchronization signals include primary synchronization signal (PSS), secondary synchronization signal (SSS), physical broadcast channel (PBCH), and demodulation reference signal (DMRS) for PBCH.

### CROSS REFERENCE

The application is a continuation of International Application No. PCT/CN2022/112501, filed on Aug. 15, 2022, the disclosure of which is hereby incorporated by reference in its entirety.

### TECHNICAL FIELD

The present disclosure relates generally to wireless communications, and in particular embodiments, beam alignment with dual-polarized antennas in a wireless communication system.

### BACKGROUND

In Fifth Generation (5G) New Radio (NR), a synchronization signal-physical broadcast channel (SS-PBCH) block (SSB) is transmitted with one antenna port, i.e. antenna port p=4000 is used for transmission of primary synchronization signal (PSS), secondary synchronization signal (SSS), physical broadcast channel (PBCH) and demodulation reference signal (DM-RS) for PBCH. An antenna port is a virtual concept and is not necessarily equivalent to transmission on a given antenna. For example, a base station (BS) may use two antennas to transmit one antenna port. A user equipment (UE) may have no knowledge of antenna architecture at the base station or how such 1-port SSB is transmitted via one or more antennas at the base station.

At frequencies in the millimeter wave (mmWave) range (e.g., 26, 38, 39, 73 GHZ) and the mid-band range (e.g., 3.5, 3.7, 4.7, 4.9 GHZ), dual-polarized antennas are widely used at the base station and the UE. With dual-polarized antennas, two linearly polarized antennas are often superposed on a same location, but separated by about 90 degrees in the polarization direction, for example, vertical and horizontal polarization directions or ±45 degree slant polarization directions. With dual-polarized antennas, independent signals can be transmitted from antennas with different polarization directions. There may be multiple antennas corresponding to the same polarization direction, for example, the first and second groups of antennas for vertical and horizontal polarization directions or ±45 degree slant polarization directions, respectively. In this case, one antenna over vertical or −45-degree slant polarization direction may be superposed with one antenna over horizontal or +45-degree polarization slant direction. It is also possible that the first and second groups of antennas for vertical and horizontal polarization directions or ±45 degree slant polarization directions are located separately, e.g., the first group of antennas at one location and the second group of antennas at another location. In such cases, the number of antennas in the first and the second groups of antennas can be same or different.

With 1-port SSB and dual-polarized antennas, typically the base station transmits a same SSB signal via dual-polarized antennas, and the UE also measures with dual-polarized antennas. In 5G NR, it is expected that a measured result should not be less than the result measured from either of the dual-polarized antennas at the UE when considered individually or polarized antennas at the UE over either polarization direction. The measured signals from the dual-polarized antennas at the UE may be compared or combined, and a decision of the exact manner of processing is left to the UE (e.g., maximum power, average power). As the same SSB signal is transmitted via dual-polarized antennas at the base station, the UE may not be able to tell which polarized antenna(s) of the base station or polarized antennas over which polarization direction the received signal is from. The base station may select one or multiple antennas over one polarization direction to transmit an SSB, but such selection is unknown to the UE.

FIG. 1A illustrates a portion of a network 10 that includes a base station 5 and a UE 20. The base station 5 is shown to have three beams 7a, 7b and 7c pointed to different directions in space. Each of the three beams 7a, 7b and 7c are actually two beams being transmitted or received in the same direction by dual-polarized antennas. For example, a first group of polarized antennas on vertical polarization direction is used to generate one beam, while a second group of polarized antennas on horizontal polarization direction is used to generate another beam pointing in a same direction but over a horizontal polarization direction. The symbol “+” shown on the three beams is in fact an indication that there is a beam in vertical polarization direction (represented by the “|” symbol) and a beam in a horizontal polarization direction (represented by “−” symbol) that are overlapping. The UE 20 is shown to have two beams 22a and 22b pointed to different directions in space. Each of the two beams 22a and 22b includes two beams being transmitted or received in the same direction by dual-polarized antennas. For example, a first group of polarized antennas on vertical polarization direction is used to generate one beam, while a second group of polarized antennas on horizontal polarization direction is used to generate another beam pointing at same direction but over horizontal polarization direction. The base station 5 and the UE 20 perform beam alignment and end up selecting base station beam 7b and UE beam 22a as a preferred beam pair for transmission or communication.

At mmWave frequencies, analog beamforming is typically adopted by both the base station and the UE in order to extend signal coverage. There is large resource overhead when performing beam sweeping at the base station side, e.g., the base station transmits 64 SSBs in every SSB period (e.g., 10 ms). Without knowledge of the base station polarization direction, the UE applies a same analog beam on the UE dual-polarized antennas, as discussed in above. In addition, beam sweeping at the UE side results in large latency for initial access. For example, the UE may need to measure all possible combinations of base station beams and UE beams and then initiate an initial access procedure. The associated delay would be equal to SSB periodicity multiplied by N, where N is equal to a number of UE beams being used for the beam sweeping.

FIG. 1B illustrates a base station 5, for which four beams 8a, 8b, 8c, and 8d are shown. Each of beams 8a, 8b, 8c, 8d are used for transmitting a separate SSB. Referring to FIG. 1B, a first beam 8a is shown to be used for transmitting SSB0. A second beam 8b is shown to be used for transmitting SSB1. A third beam 8c is shown to be used for transmitting SSB2. A fourth beam 8d is shown to be used for transmitting SSB3. These four beams 8a, 8b, 8c, and 8d and corresponding SSBs are only considered as a portion of beam-swept SSB transmission in an entire SSB period 30. Additional, or fewer, beams may be used in an actual implementation, but four are shown in FIG. 1B as an example.

Also illustrated in FIG. 1B are portions of two SSB periods in a time and frequency resource plane 35 in which time is on the horizontal axis and frequency is on the vertical axis. Only four SSBs in each SSB period 30 are shown. Each SSB of SSB0, SSB1, SSB2, SSB3, is transmitted over a different time and frequency resource 39a, 39b, 39c and 39d, respectively. As can be seen, when increasing the number of SSBs, the amount of time and frequency resource consumed for beam-swept SSB transmission will increase linearly.

FIG. 1C illustrates multiple SSB periods during which each SSB is transmitted in a time and frequency resource by a base station, where time is indicated on the horizontal axis and frequency is indicated on the vertical axis. Also shown for the first two SSB periods are dual-polarized antennas at the UE as indicated by the “+” symbol that are receiving multiple SSBs within one SSB period from the same direction in space from UE perspective.

In 5G NR, for a non-terrestrial network (NTN) scenario, i.e. where some base stations are mobile base stations such as drones or satellites, a method of per-cell indication of polarization type among left-handed circular polarization (LHCP), right-handed circular polarization (RHCP), or linear polarization (LP) is supported. The SSBs in one cell are transmitted with either LHCP, RHCP, or LP. For a serving cell, a type of polarization indication may be provided via system information block (SIB) signaling. For a target cell during a handover procedure, such polarization type indication may be provided in a handover command. For a neighbor cell and/or non-serving cell during a radio resource management (RRM) measurement, such polarization type indication may be provided in RRM configuration. Use of a method for indication of base station polarization type may help reduce measurement complexity at the UE, i.e., reduced complexity of blind detection of base station polarization type.

Also for 5G NR NTN, it was proposed to have a method involving per-SSB/beam polarization type indication. It was also proposed to transmit time division multiplexed (TDMed) even- or odd-indexed SSBs with LHCP or RHCP, respectively. In both cases, it was proposed that each SSB to be assigned with one polarization type that is indicated or made known to the UE. This was proposed to enable polarization-based multiplexing of transmissions from multiple base stations toward multiple UEs. These two proposals were not adopted into wireless communication standards due to the fact that a satellite is typically incapable of switching between LHCP or RHCP dynamically or transmitting LHCP and RHCP simultaneously.

The above-described methods suggested for 5G NTN (i.e., per-cell/SSB/beam indication of polarization type) are not viable for scenarios with dual-polarized antennas. For the above-described methods, with a same SSB signal transmitted from dual-polarized antennas and over only one antenna port, it is not possible for the UE to distinguish the signals simultaneously transmitted from dual-polarized antennas at the base station, i.e., it is not possible for the UE to identify over which polarization direction the received signal is transmitted from the base station antenna(s). In addition, even with the above-described methods, large resource overhead from base station beam sweeping or large latency for initial access from UE beam sweeping are issues that are problematic.

### SUMMARY

Aspect of the present disclosure provide solutions to overcome the shortcomings described above, as well as specific methods for beam alignment with dual-polarized antennas aiming at faster beam-based initial access and lower overhead from beam sweeping. Aspect of the disclosure provide solutions to reduce large latency and large resource overhead that would otherwise occur as part of an initial access procedure in multi-beam systems.

In some aspects of the disclosure, there is provided a method involving: transmitting, on at least one beam, a synchronization signal (SS)/physical broadcast channel (PBCH) block (SSB) on two antenna ports, the transmitting using a pattern for which the first and second antenna ports of the SSB are associated with polarization directions of antennas or polarization directions in relation to a reference plane, wherein each of the two antenna ports is transmitted via one or more antenna(s) on one polarization direction.

In some embodiments, the SSB comprises one or more of: one or more primary synchronization signal (PSS); one or more secondary synchronization signal (SSS); a physical broadcast channel (PBCH); and one or more demodulation reference signal (DM-RS) for PBCH.

In some embodiments, the pattern comprises: the same PSS, PBCH-DMRS, and PBCH being transmitted over the two antenna ports and SSS sequences are grouped into pairs, wherein for each pair of SSS sequences, a first SSS sequence is transmitted via the first antenna port and a second SSS sequence is transmitted via the second antenna port.

In some embodiments, the pattern comprises: the same PSS, SSS, and PBCH being transmitted over the two antenna ports and two orthogonal PBCH-DMRS are generated with time and/or frequency domain orthogonal cover code (OCC), wherein the two orthogonal PBCH-DMRS are transmitted over the two antenna ports, wherein a first PBCH-DMRS is transmitted via the first antenna port and a second PBCH-DMRS is transmitted via the second antenna port.

In some embodiments, the pattern comprises: the same SSS, PBCH-DMRS, and PBCH being transmitted over the two antenna ports and the PSS sequences are grouped into pairs, wherein for each pair of PSS sequences, a first PSS sequence is transmitted via the first antenna port and a second PSS sequence is transmitted via the second antenna port.

In some embodiments, transmitting the SSB on two antenna ports comprises transmitting the first antenna port of the SSB on a first beam and transmitting the second antenna port of the SSB on a second beam, wherein the first beam and second beam are transmitted in different directions.

In some embodiments, the method further involves transmitting configuration information indicating the pattern.

In some aspects of the disclosure, there is provided a device including: a processor and a computer-readable storage media. The computer-readable storage media having stored thereon, computer executable instructions, that when executed by the processor, perform a method as described above or detailed below.

In some embodiments, the device is a base station.

In some aspects of the disclosure, there is provided a method involving: receiving, on at least one beam, at a receiver, a synchronization signal (SS)/physical broadcast channel (PBCH) block (SSB) that has been transmitted on two antenna ports with a pattern for which the first and second antenna ports of SSB are associated with polarization directions of antennas or polarization directions in relation to a reference plane, wherein each of the two antenna ports is transmitted via one or more antenna(s) on one polarization direction.

In some embodiments, the SSB comprises one or more of: one or more primary synchronization signal (PSS); one or more secondary synchronization signal (SSS); a physical broadcast channel (PBCH); and one or more demodulation reference signal (DM-RS) for PBCH.

In some embodiments, the pattern comprises: the same PSS, PBCH-DMRS, and PBCH being transmitted over the two antenna ports and the SSS sequences are grouped into pairs, wherein for each pair of SSS sequences, a first SSS sequence is transmitted via the first antenna port and a second SSS sequence is transmitted via the second antenna port.

In some embodiments, the pattern comprises: the same PSS, SSS, and PBCH being transmitted over the two antenna ports and two orthogonal PBCH-DMRS are generated with time and/or frequency domain orthogonal cover code (OCC) or code division multiplexing (CDM), wherein the two orthogonal PBCH-DMRS are transmitted over the two antenna ports, wherein a first PBCH-DMRS is transmitted via the first antenna port and a second PBCH-DMRS is transmitted via the second antenna port.

In some embodiments, the pattern comprises: the same SSS, PBCH-DMRS, and PBCH being transmitted over the two antenna ports and the PSS sequences are grouped into pairs, wherein for each pair of PSS sequences, a first PSS sequence is transmitted via the first antenna port and a second PSS sequence is transmitted via the second antenna port.

In some embodiments, receiving the SSB that has been transmitted on two antenna ports comprises receiving the first antenna port of the SSB that is transmitted on a first beam and receiving the second antenna port of the SSB that is transmitted on a second beam, wherein the first beam and second beam are transmitted in different directions.

In some embodiments, the method further involves receiving configuration information indicating the SSB pattern.

In some embodiments, the receiving at the receiver comprises: receiving the SSB on two different receive beams, wherein each receive beam corresponds to one polarization direction.

In some embodiments, the method further involves measuring a signal strength of a signal received on at least one receive beam corresponding to one polarization direction; and subsequent to the measured signal strength exceeding a threshold, initiating an initial access procedure.

In some aspects of the disclosure, there is provided a device including: a processor and a computer-readable storage media. The computer-readable storage media having stored thereon, computer executable instructions, that when executed by the processor, perform a method as described above or detailed below.

In some embodiments, the device is a user equipment.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1A is a schematic diagram illustrating transmission and reception for 1-port SSB with dual-polarized antennas.

FIG. 1B is a schematic diagram illustrating transmission behavior and resource overhead for transmitting multiple SSBs over corresponding base station beams.

FIG. 1C is a schematic diagram illustrating latency occurring from UE beam sweeping for beam-based initial access.

FIG. 2A is a schematic diagram of a communication system in which embodiments of the disclosure may occur.

FIG. 2B is another schematic diagram of a communication system in which embodiments of the disclosure may occur.

FIG. 3 is a block diagram illustrating units or modules in a device in which embodiments of the disclosure may occur.

FIG. 4 is a block diagram illustrating units or modules in a device in which embodiments of the disclosure may occur.

FIG. 5A is a schematic diagram illustrating an example of a 2-port SSB pattern according to some embodiments of the present disclosure.

FIG. 5B is a schematic diagram illustrating another example of a 2-port SSB pattern according to some embodiments of the present disclosure.

FIG. 5C is a schematic diagram illustrating another example of a 2-port SSB pattern according to some embodiments of the present disclosure.

FIG. 6 is a schematic diagram illustrating a mapping between SSB port and polarized antennas at base station or polarization directions in space according to an aspect of the present disclosure.

FIG. 7 is a schematic diagram illustrating two concurrent UE beams to measure 2-port SSBs according to an aspect of the present disclosure.

FIG. 8 illustrates an example for latency reduction that may be used for UE beam sweeping based on 2-port SSBs according to an aspect of the present disclosure.

FIG. 9 illustrates an example of transmission behavior and resource overhead for 2-port SSB with two concurrent base station beams, in accordance with embodiments of the present disclosure.

FIG. 10 is an example of a signaling flow diagram for signaling between a base station and a UE in accordance with embodiments of the present disclosure.

### DETAILED DESCRIPTION

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Aspects of the disclosure may exploit use of dual-polarized antennas at the base station and the UE to at least one of reducing latency during beam-based initial access or reducing resource overhead resulting from beam sweeping. In some embodiments, this may be implemented by establishing a mapping relation between synchronization signals and polarization directions of dual-polarized antennas at the base station or polarization directions in relation to a reference plane. In some embodiments, the reference plane may be the surface of the earth. Examples of synchronization signals include primary synchronization signal (PSS), secondary synchronization signal (SSS), physical broadcast channel (PBCH), and demodulation reference signal (DM-RS) for PBCH. When distinguishable synchronization signals are transmitted from dual-polarized antennas at the base station under the same base station beam, together with the above-mentioned mapping relation, the UE may be able to measure two different receive beams using dual-polarized antennas simultaneously, which may reduce the latency for initial access. While the phrase “initial access” is used above and subsequently below, the phrase “initial access” may be replaced with “contention-based random access” or “contention-free random access”. In some embodiments, by enabling the base station to transmit two beams simultaneously using dual-polarized antennas, where each beam corresponding to one polarization direction and one synchronization signal, the resource overhead for base station beam sweeping to transmit synchronization signals in multi-beam systems may be reduced.

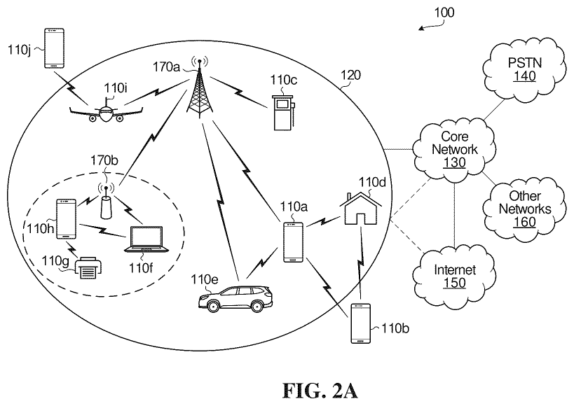

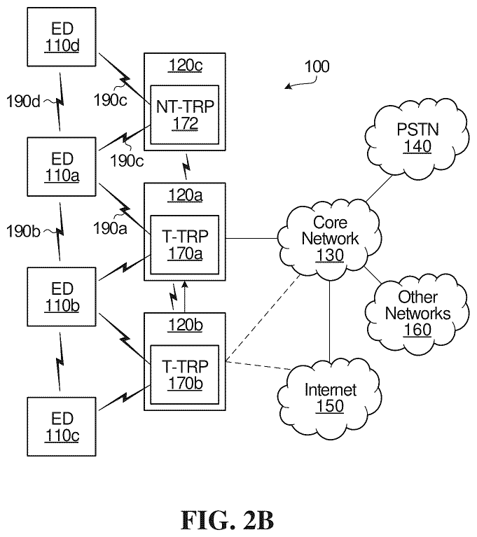

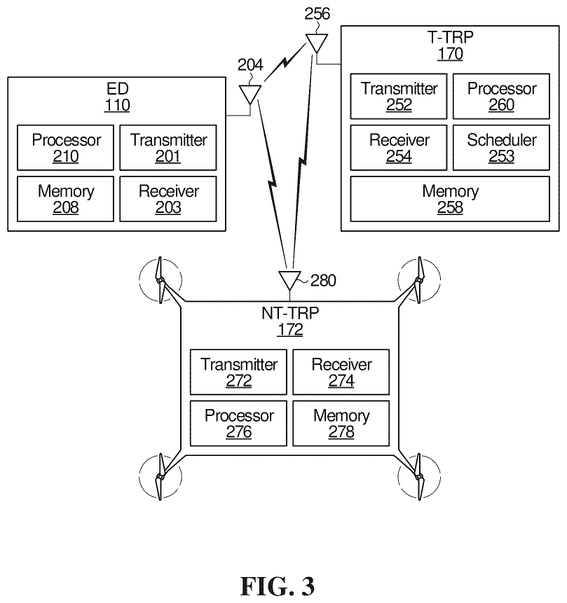

FIGS. 2A, 2B, and 3 following below provide context for the network and device that may be in the network and that may implement aspects of the present disclosure.

Referring to FIG. 2A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 2B illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 2B, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 2B illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110d, radio access networks (RANs) 120a-120c, a core network 130, a public switched telephone network (PSTN) 140, the internet 150, and other networks 160. Although certain numbers of these components or elements are shown in FIG. 2B, any reasonable number of these components or elements may be included in the communication system 100.

The EDs 110a-110d are configured to operate, communicate, or both, in the communication system 100. For example, the EDs 110a-110d are configured to transmit, receive, or both, via wireless or wired communication channels. Each ED 110a-110d represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 2B, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110d may be alternatively or additionally configured to interface, access, or communicate with any other base station 170a-170b, the internet 150, the core network 130, the PSTN 140, the other networks 160, or any combination of the preceding.

The EDs 110a-110d and base stations 170a-170b, 172 are examples of communication equipment that can be configured to implement some or all of the operations and/or embodiments described herein. In the embodiment shown in FIG. 2B, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 communicate with one or more of the EDs 110a-110c over one or more air interfaces 190a, 190c using wireless communication links e.g. radio frequency (RF), microwave, infrared (IR), etc. The air interfaces 190a, 190c may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a, 190c.

A base station 170a-170b, 172 may implement Universal Mobile Telecommunication System (UMTS) Terrestrial Radio Access (UTRA) to establish an air interface 190a, 190c using wideband CDMA (WCDMA). In doing so, the base station 170a-170b.172 may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b,172 may establish an air interface 190a,190c with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110d communicate with one another over one or more sidelink (SL) air interfaces 190b, 190d using wireless communication links e.g. radio frequency (RF), microwave, infrared (IR), etc. The SL air interfaces 190b, 190d may utilize any suitable radio access technology, and may be substantially similar to the air interfaces 190a, 190c over which the EDs 110a-110c communication with one or more of the base stations 170a-170b, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190b, 190d. In some embodiments, the SL air interfaces 180 may be, at least in part, implemented over unlicensed spectrum.

In addition, some or all of the EDs 110a-110d may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110d may be multimode devices capable of operation according to multiple radio access technologies, and incorporate multiple transceivers necessary to support multiple radio access technologies.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

FIG. 3 illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 2A or 2B). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 3. FIG. 3 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

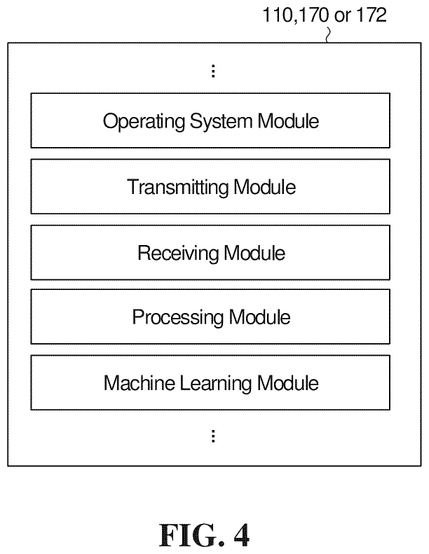

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. A new protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

In some embodiments, a 2-port SSB pattern is provided. Each SSB is transmitted with two antenna ports. The SSB includes one or more of PSS, SSS, PBCH-DMRS, and PBCH. In some embodiments, each antenna port is transmitted via one or multiple BS antenna(s) on one polarization direction. For example, a first port may be transmitted via one or multiple vertically polarized antenna(s) and a second port may be transmitted via one or multiple horizontally polarized antenna(s). In another example, the first port may be transmitted via one or multiple-45 degree slantingly polarized antenna(s) and the second port may be transmitted via one or multiple +45 degree slantingly polarized antenna(s). Three different examples of possible sequence generation and mapping schemes are provided below.

In the first example, the same PSS, PBCH-DMRS, and PBCH is transmitted over two antenna ports, which as described above, each antenna port corresponds to one or multiple antenna(s) over one polarization direction. However, the SSS sequences are grouped into pairs of sequences. For each SSS pair, the first SSS sequence of the pair is transmitted via a first antenna port, corresponding to one or multiple antenna(s) over a first polarization direction, while the second SSS sequence of the pair is transmitted via a second antenna port, corresponding to one or multiple antenna(s) over a second polarization direction. For example, SSS #0 is transmitted via antenna port0, and SSS #1 is transmitted via antenna port1. In some embodiments, this may enable early detection of base station polarization directions during SSS detection. This may be the case because once a UE detects the first, or second, SSS sequence in a given SSS pair, the UE has detected a signal transmitted from either vertically polarized antenna(s) or horizontally polarized antenna(s) of the base station, or either −45 degree slantingly polarized antenna(s) or +45 degree slantingly polarized antenna(s) of the base station. In such a case, a physical cell identifier (ID) that may be used for subsequent detection, may be derived from the PSS and one SSS of each SSS pair, either the first or the second SSS. For example, the physical cell ID may be obtained from the PSS and the first SSS in each SSS pair. In this case, even if the UE detects the second SSS in the SSS pair, the UE may determine the physical cell ID from the first SSS of the SSS pair. One SSS pair may be formed by selecting a second SSS from all SSS sequences that yields the lowest cross-correlation with a given first SSS. As an alternative implementation of this example, the PSS, PBCH-DMRS, and PBCH may alternatively be transmitted with only one antenna port among the two antenna ports used for transmitting the SSS pair, where the one antenna port may be transmitted via antennas on both polarization directions.

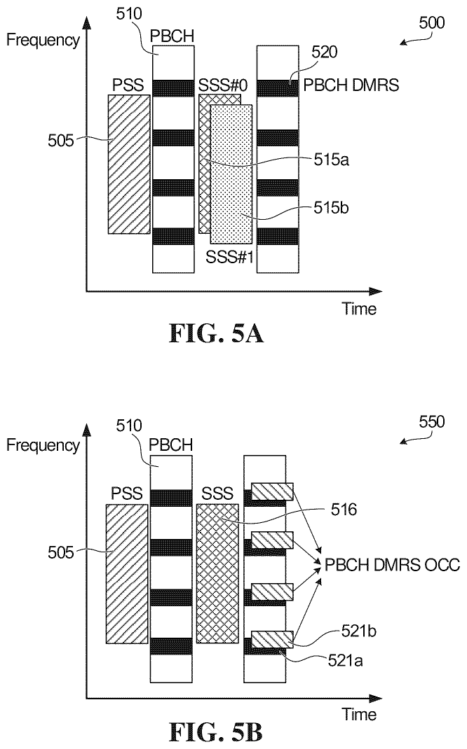

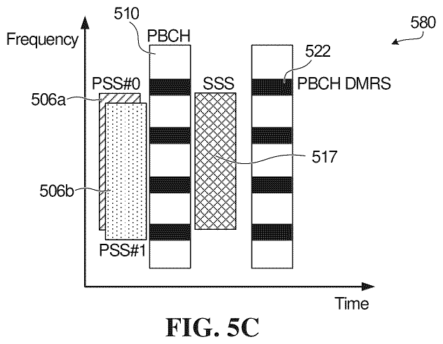

FIG. 5A illustrates a representation of a time and frequency resource 500 that includes PSS 505, PBCH 510, SSS 515a, 515b, and PBCH DM-RS 520. The horizontal axis represents time and the vertical axis represents frequency. The two SSS sequences 515a and 515b in an SSS pair are transmitted over the same time and frequency resources, as indicated by the overlapping sequences 515a, 515b in FIG. 5A. While the two SSS sequences 515a and 515b in the SSS pair are transmitted over the same time and frequency resources, the two SSS sequences are transmitted via antennas having different polarization directions. To reduce cross-polarization interference during SSS detection, in some embodiments, the two SSS sequences 515a and 515b may be transmitted on different time and/or frequency resources.

In the second example, the same PSS, SSS, and PBCH is transmitted over two antenna ports, which as described above, each antenna port corresponds to one or multiple antenna(s) over one polarization direction. Two orthogonal PBCH-DMRS generated with time and/or frequency domain orthogonal cover code (OCC) or code division multiplexing (CDM) are transmitted over two antenna ports, corresponding to two polarization directions. A first PBCH-DMRS is transmitted via a first antenna port corresponding to one or multiple antenna(s) over a first polarization direction and a second PBCH-DMRS is transmitted via a second antenna port corresponding to one or multiple antenna(s) over a second polarization direction. In such a case, once the UE detects the first or second PBCH-DMRS, the UE knows the UE has detected a signal transmitted from either vertically polarized antennas or horizontally polarized antennas of the base station, or either −45 degree slantingly polarized antenna(s) or +45 degree slantingly polarized antenna(s) of the base station. In this embodiment, there is typically no impact on synchronization signal (SS). As an alternative implementation of this example, the PSS, SSS, and PBCH may alternatively be transmitted with only one antenna port among the two antenna ports used for transmitting the two orthogonal PBCH-DMRS, where the one antenna port may be transmitted via antennas on both polarization directions.

FIG. 5B illustrates a representation of a time and frequency resource 550 that includes PSS 505, PBCH 510, SSS 516, and PBCH DMRS 521a, 521b. The two PBCH DMRS 521a and 521b are transmitted over the same time and frequency resources, as indicated by the overlapping sequences 521a, 521b in FIG. 5B. While the two PBCH DM-RS 521a and 521b are transmitted over the same time and frequency resources, the two PBCH DMRS 521a and 521b are transmitted on antennas over different polarization directions. In some embodiments, to further reduce detection complexity at the UE, the two orthogonal PBCH-DMRS may be generated with time or frequency domain multiplexing, i.e., mapped on different time or frequency resources. In FIG. 5B, as an example, four resource elements are used to carry two orthogonal PBCH-DMRS, and the OCC or orthogonal sequences can be any two of {[+1,+1,+1,+1], [+1, −1,+1, −1], [+1,+1, −1, −1], [+1, −1, −1,+1]}. In some embodiments, when two resource elements are used to carry two orthogonal PBCH-DMRS, the OCC or orthogonal sequences can be {[+1, +1], [+1, −1]}.

In the third example, the same SSS, PBCH-DMRS, and PBCH is transmitted over two antenna ports, which as described above each antenna port corresponds to one or multiple antenna(s) over one polarization direction. The PSS sequences are grouped into pairs. For each PSS pair of sequences, a first PSS sequence is transmitted via a first antenna port corresponding to one or multiple antenna(s) over a first polarization direction, while a second PSS sequence is transmitted via a second antenna port corresponding to one or multiple antenna(s) over a second polarization direction. For example, PSS #0 is transmitted via the first antenna port and PSS #1 is transmitted via the second antenna port. Embodiments such as this may enable earlier detection of base station polarization direction, i.e., during PSS detection. This may be the case because once a UE detects the first or second PSS sequence in one PSS pair, the UE has detected a signal transmitted from either vertically polarized antenna(s) or horizontally polarized antenna(s) of the base station, or either −45 degree slantingly polarized antenna(s) or +45 degree slantingly polarized antenna(s) of the base station. In such a case, a physical cell ID that may be used for subsequent detection, may be derived from the SSS and one PSS of each PSS pair, either the first or the second PSS. For example, the physical cell ID may be obtained from the SSS and the first PSS in each PSS pair. Even if the UE detects the second PSS in the PSS pair, the UE may determine the physical cell ID from the first PSS of the PSS pair. As an alternative implementation of this example, the SSS, PBCH-DMRS, and PBCH may alternatively be transmitted with only one antenna port among the two antenna ports used for transmitting the PSS pair, where the one antenna port may be transmitted via antennas on both polarization directions.

FIG. 5C illustrates a representation of a time and frequency resource 580 that includes PSS 506a, 506b, PBCH 510, SSS 517, and PBCH DMRS 522. The horizontal axis represents time and the vertical axis represents frequency. The two PSS sequences 506a and 506b in a PSS pair are transmitted over the same time and frequency resources, as indicated by the overlapping sequences 506a, 506b in FIG. 5C. While the two PSS sequences 506a and 506b in the PSS pair are transmitted over the same time and frequency resources, the two PSS sequences are transmitted via antennas having different polarization directions. In some embodiments, to reduce cross-polarization interference during PSS detection, the two PSS sequences 506a and 506b may be transmitted on different time and/or frequency resources. One PSS pair may be formed by selecting a second PSS from all PSS sequences that yields the lowest cross-correlation with a given first PSS.

While dual-polarized antennas with 2 polarization directions and 2-port SSB are described in the examples of FIGS. 5A to 5C and in the various embodiments described above and below, it should be understood that the aspects described herein could be extended to multi-polarized antennas with M polarization directions and M-port SSB, where M is greater than 2.

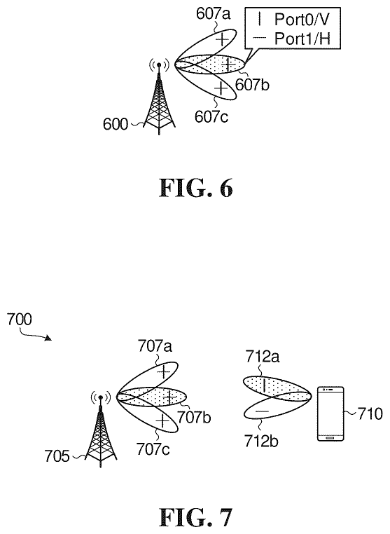

In FIG. 6, the base station 600 is shown having three beams 607a, 607b, and 607c, where each of the beams are transmitted via dual-polarized antennas at the base station. For each beam direction, one or multiple vertically polarized antenna(s) are used to transmit SSB port0, while one or multiple horizontally polarized antenna(s) are used to transmit SSB port1. In some embodiments, one or multiple vertically polarized antenna(s) are used to transmit SSB port1, while one or multiple horizontally polarized antenna(s) are used to transmit SSB port0. For any of the three examples of sequence generation and mapping schemes described above, once one antenna port from a 2-port SSB is detected by a UE, the UE is able to identify which polarization direction the received signal is transmitted from (e.g., transmitted from vertically or horizontally polarized antennas at the base station).

In the examples of sequence generation and mapping schemes described above, the base station utilizes two antenna ports in one SSB to represent two polarization directions and/or base station antennas over two polarization directions. When one antenna port is detected at the UE, the UE knows the antenna port is transmitted from a particular polarization direction and/or base station antennas over one particular polarization direction.

In some embodiments, two polarization directions and/or base station antennas over two polarization directions may be associated with two SSBs, which are transmitted over two antenna ports, over the same or different time and/or frequency resources. For example, a first SSB is transmitted via a first antenna port corresponding to a first polarization direction and/or base station antennas over a first polarization direction, while a second SSB is transmitted via a second polarization direction and/or base station antennas over a second polarization direction. Once one SSB is detected at the UE, the UE knows the received signal is from a particular polarization direction and/or base station antennas over a particular polarization direction.

In some embodiments, the UE is able to identify the received signal is from a given polarization direction and/or polarized antennas of the base station over one polarization direction during initial access procedure. In some embodiments, the UE is able to estimate a polarization change introduced by a channel between the base station and UE and may reduce detection complexity at the UE.

In some embodiments, a new UE measurement behavior is provided for a 2-port SSB pattern with a single base station transmit beam. For example, a UE search for SSB for initial downlink (DL) beam alignment and DL timing and frequency synchronization. When the base station is transmitting 2-port SSB with one base station transmit beam, and one antenna port of this 2-port SSB corresponds to one polarization direction or base station antennas over one polarization direction, the UE may decouple the dual-polarized antennas and measure two UE receive beams at the same time. For example, a UE may apply a first receive beamforming weight on one or multiple antenna(s) on a first polarization direction and a second receive beamforming weight on one or multiple antenna(s) on a second polarization direction. With possible UE orientation change, the first and the second polarization directions herein are described from the UE perspective, and may be the same or different from the polarization directions discussed in previous embodiments (i.e., vertical and horizontal polarization directions or +45 degree slant polarization directions in relation to the surface of the earth).

FIG. 7 illustrates a portion of a network 700 that includes a base station 705 and a UE 710. Three base station transmit beams 707a, 707b and 707c are shown. Each of the base station transmit beams 707a, 707b and 707c are shown to include two polarization directions indicated by the overlapping horizontal and vertical lines that are represented by the “+” symbol. The UE 710 is shown to have two concurrent receive beams over two polarization directions. A first beam 712a is shown to be on vertical polarization direction (|) and a second beam 712b is shown to be on horizontal polarization direction (−). These two polarization directions may shift as the UE changes its orientation or switches receiving panels or antennas. The two concurrent UE receive beams 712a and 712b may help reduce latency for UE-side beam sweeping during initial access procedure.

Two examples are described below for UE measurement behavior according to aspects of the disclosure.

In a first example, on each UE receive beam, which corresponds to one polarization direction, the UE detects both antenna ports in one SSB. Once the quality of one SSB-port measured by one UE receive beam on a particular polarization direction exceeds a certain threshold, the UE may initiate an initial access procedure. In this example, the UE is responsible for more computational effort, but the chance of mis-detection by the UE may be reduced.

In a second example, on the UE receive beam that is with X polarization direction, the UE detects SSB ports corresponding to the X polarization direction only, where X=vertical or horizontal or X=−45° or +45° degree slant. This example may be suited to scenarios where the polarization change introduced by the propagation channel is limited to a pre-determined maximum value and the UE is able to align polarization directions of the UE antennas with the polarization directions of the base station antennas taking into consideration the UE orientation and antenna placement. Being able to align polarization directions of the UE antennas with the base station may involve switching receive antennas or performing projection onto a particular polarization plane or direction or combining signals received from dual polarized antennas with certain weights. Performing this type of measurement may help reduce measurement complexity at the UE.

In some embodiments, in each SSB period, the UE measures with two UE beams where each beam is on one polarization direction. This should, on average, enable two times faster beam-based initial access, i.e., the longest latency for beam-based initial access reduces to SSB periodicity×N/2, where N is the number of UE beams.

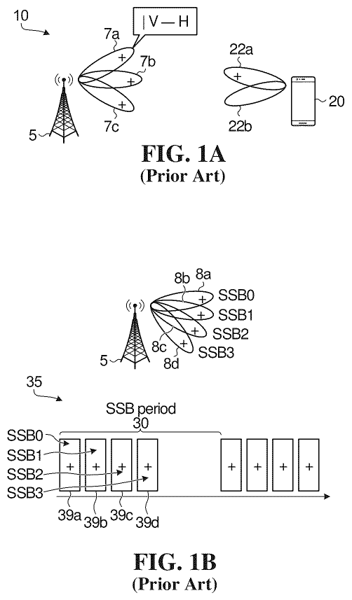

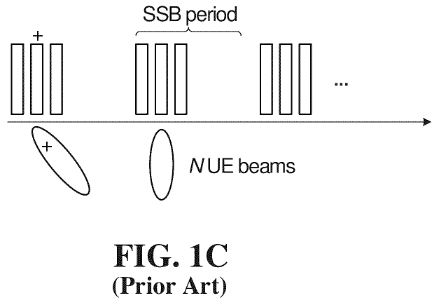

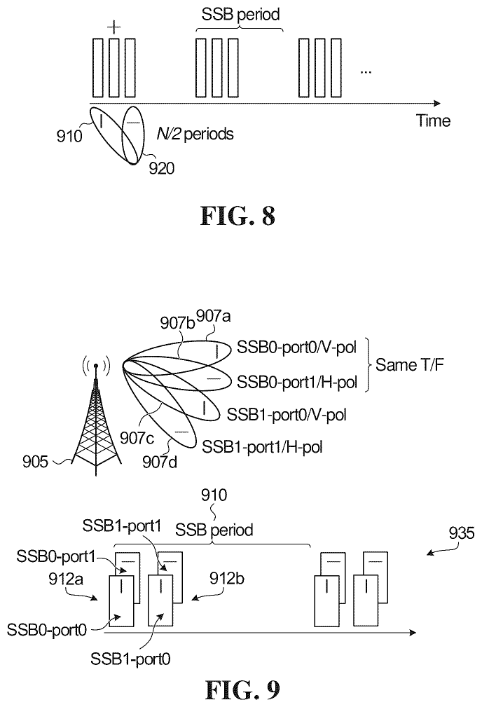

FIG. 8 is similar to the multiple SSB period arrangement shown in FIG. 1C, but instead of having a single UE receive beam for the dual-polarized antennas at the UE in each SSB period as shown in FIG. 1C, there are two concurrent UE beams 910, 920 with each beam on a respective polarization direction. As compared to FIG. 1C, because there are two beams at the UE for each SSB period, the associated overall latency is reduced by half.

In some embodiments, the UE is able to perform faster UE-side beam training and thereby faster beam-based initial access especially at mmWave frequencies.

In some embodiments, a 2-port SSB pattern is provided, where each antenna port of the SSB is transmitted via one or multiple base station antenna(s) on one polarization direction and one base station transmit beam. In this case, there are two concurrent base station transmit beams transmitting two antenna ports of a 2-port SSB. The two antenna ports in a 2-port SSB may be identified or differentiated via sequence generation and mapping schemes that are described above.

FIG. 9 illustrates a base station 905, for which four beams 907a, 907b, 907c, and 907d are shown. These four beams 907a, 907b, 907c, and 907d are only considered as a portion of an entire SSB period 910 in a time and frequency resource plane 935, in which time is on the horizontal axis and frequency is on the vertical axis. Additional, or fewer, beams may be used in an actual implementation, but four are shown in FIG. 9 as an example. Pairs of beams (a first pair being 907a, 907b and a second pair being 907c, 907d) are used for transmitting each 2-port SSB, where a first beam 907a, 907c of each pair is used for a first polarization direction, such as vertical polarization (V-pol), and a second beam 907b, 907d of each pair is used for a second polarization direction, such as horizontal polarization (H-pol). Referring to FIG. 9, a first beam 907a is shown to be used for transmitting SSB0-port0, which is transmitted by one or multiple antenna(s) having a vertical polarization direction. A second beam 907b is shown to be used for transmitting SSB0-port1, which is transmitted by one or multiple antenna(s) having a horizontal polarization direction. A third beam 907c is shown to be used for transmitting SSB1-port0, which is transmitted by one or multiple antenna(s) having a vertical polarization direction. A fourth beam 907d is shown to be used for transmitting SSB1-port1, which is transmitted by one or multiple antenna(s) having a horizontal polarization direction.

Also illustrated in FIG. 9 are portions of two SSB periods in the time and frequency resource plane 935 for which only two 2-port SSBs in each SSB period are shown as an example. As both antenna ports of each SSB are transmitted over the same time and frequency resource 912a, 912b, the resource overhead for covering the same angular/spatial area via beam sweeping is reduced by half. In some embodiments, it may be possible to further reduce overhead with multi-polarized antennas with M polarization directions and M-port SSB where M is greater than 2.

Two examples are described below for UE measurement behavior for 2-port SSB pattern with two concurrent base station beams according to aspects of the present disclosure.

In a first example, the UE applies a same beamforming weight on the UE dual-polarized antennas to measure or search for both antenna ports of 2-port SSB. In this way, the UE measures two base station transmit beams at one SSB occasion. This example may provide robustness against UE movement and/or rotation and polarization change that may be introduced by the propagation channel.

In a second example, the UE applies two different receive beamforming weights with UE antennas on two different polarization directions, and on each receive beamforming weight, the UE detects the SSB antenna ports corresponding to the same or similar polarization direction (e.g., vertical or horizontal or −45° or +45° degree slant polarization direction). This example may be suited to scenarios where the polarization change introduced by the propagation channel is limited to a pre-defined maximum value and the UE is able to align polarization directions of the UE antennas with the polarization directions of antennas at the base station taking into consideration the UE orientation and antenna placement. Being able to align polarization directions of the UE antennas with the base station may involve switching receive antennas or performing projection onto a particular polarization plane or direction or combining signals received from dual-polarized antennas with certain weights. This scheme may help reduce measurement complexity at the UE.

In some embodiments, the above described 2-port SSB pattern are applicable for a first frequency range (e.g., mid-band frequency such as 3.5 GHZ, mmWave frequency such as 28, 39, 73 GHZ), while the existing 1-port SSB pattern are applicable for a second frequency range (e.g., low-band frequency such as 700, 900 MHz). A UE operating in one frequency range should try to detect a corresponding SSB pattern, so the number of antenna ports in SSBs may be pre-determined and adapted to the number of distinguishable polarization directions at a given frequency range, and there may be no need to have a signaling exchange between the base station and the UE regarding the applicable SSB pattern.

In some embodiments, for non-standalone deployment where the UE has been connected to the network or base station via a first carrier (e.g., a carrier in mid-band frequency such as 3.5 GHz), the number of antenna ports in SSBs in a second carrier (e.g., a carrier at mmWave frequency such as 28, 39, 73 GHZ) may be indicated to UE via radio resource control (RRC), medium access control (MAC) control element (CE), or downlink control information (DCI) signaling over the first carrier. Such information may help reduce UE complexity for detecting a number of antenna ports in SSB on the second carrier. In some embodiments, for non-standalone deployment where the UE has been connected to the network or base station via a first carrier (e.g., a carrier in mid-band frequency such as 3.5 GHZ), if there is no indication regarding the number of antenna ports in SSBs in a second carrier (e.g., a carrier at mmWave frequency such as 28, 39, 73 GHZ), the UE may assume the SSBs on the second carrier are with one or two antenna port(s).

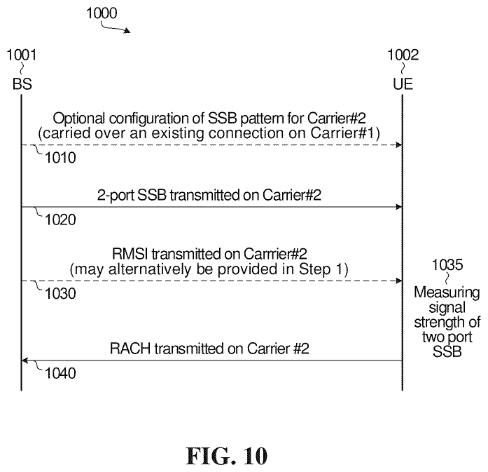

FIG. 10 is a signal flow diagram 1000 that illustrates signal transmission and reception between a base station (BS) 1001 and a UE 1002 in accordance with embodiments of the present disclosure. In some embodiments, such as for non-standalone deployment where the UE 1002 is connected to a network or the base station 1001 via a first carrier (e.g., Carrier #1), a number of antenna ports in SSBs in a second carrier (e.g., Carrier #2) may be provided to UE 1002 via configuration information signaling in a first signaling 1010. In other embodiments, such as for standalone deployment where the UE 1002 detects a 2-port SSB pattern as a default functionality, the first signaling 1010 may be skipped.

At step 1020, the base station 1001 transmits the 2-port SSB on the second carrier to the UE 1002. In some embodiments, the 2-port SSB may be transmitted with a pattern described above, for example, the patterns in any of FIG. 5A, 5B or 5C or as described with regard to FIG. 9.

In some embodiments, at step 1030, the base station transmits remaining minimum system information (RMSI) that includes system information block #1 (SIB #1) and/or other system information (OSI) on the second carrier, where SIB #1 is needed for RACH procedure. In some embodiments, the RMSI may be transmitted as part of the configuration information in the first signaling 1010. In some embodiments, the UE measurements may be made in a manner consistent with a single UE receive beam direction on both polarization directions or with two concurrent UE receive beam directions on two polarization directions, for example as shown in FIG. 7

The UE 1002 measures 1035 the signal strength of one or both antenna ports of the 2-port SSB. Measuring one or both antenna ports of the 2-port SSB may include any of: one or more primary synchronization signal (PSS); one or more secondary synchronization signal (SSS); a physical broadcast channel (PBCH); and one or more demodulation reference signal (DM-RS) for PBCH.

At step 1040, the UE 1002 transmits a random access channel (RACH) on the second carrier to the base station 1001. In some embodiments, the RACH may be transmitted after a measured signal strength of a signal received on at least one UE receive beam corresponding to one polarization direction exceeds a threshold, as part of initiating an initial access procedure.

In some embodiments, resource overhead from base station beam sweeping for transmitting synchronization signals may be reduced and latency for initial access from UE beam sweeping may also be reduced.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising:
transmitting, on at least one beam, a synchronization signal (SS)/physical broadcast channel (PBCH) block (SSB) on two antenna ports including a first antenna port and a second antenna port, the transmitting using a pattern for which the first antenna port and the second antenna port of the SSB are associated with polarization directions of antennas or polarization directions in relation to a reference plane, wherein each of the two antenna ports is transmitted via one or more antennas on one polarization direction.

2. The method of claim 1, wherein the SSB comprises one or more of:
one or more primary synchronization signals (PSSs);
one or more secondary synchronization signals (SSSs);
a PBCH; or
one or more demodulation reference signal (DMRSs) for the PBCH.

3. The method of claim 1, wherein the pattern comprises: a same PSS, a same PBCH-DMRS, and a same PBCH being transmitted over the two antenna ports and SSS sequences being grouped into pairs, and wherein for each pair of the SSS sequences, a first SSS sequence is transmitted via the first antenna port, and a second SSS sequence is transmitted via the second antenna port.

4. The method of claim 1, wherein the pattern comprises: a same PSS, a same SSS, and a same PBCH being transmitted over the two antenna ports and two orthogonal PBCH-DMRSs being generated with time or frequency domain orthogonal cover code (OCC) or code division multiplexing (CDM), wherein the two orthogonal PBCH-DMRSs are transmitted over the two antenna ports, wherein a first PBCH-DMRS of the two orthogonal PBCH-DMRSs is transmitted via the first antenna port, and wherein a second PBCH-DMRS of the two orthogonal PBCH-DMRSs is transmitted via the second antenna port.

5. The method of claim 1, wherein the pattern comprises: a same SSS, a same PBCH-DMRS, and a same PBCH being transmitted over the two antenna ports and PSS sequences being grouped into pairs, wherein for each pair of the PSS sequences, a first PSS sequence is transmitted via the first antenna port, and a second PSS sequence is transmitted via the second antenna port.

6. The method of claim 1, wherein the transmitting the SSB on the two antenna ports comprises:
transmitting the first antenna port of the SSB on a first beam and transmitting the second antenna port of the SSB on a second beam, wherein the first beam and second beam are transmitted in different directions.

7. A method comprising:
receiving, on at least one beam, at a receiver, a synchronization signal (SS)/physical broadcast channel (PBCH) block (SSB) that has been transmitted on two antenna ports including a first antenna port and a second antenna port using a pattern for which the first antenna port and the second antenna port of the SSB are associated with polarization directions of antennas or polarization directions in relation to a reference plane, wherein each of the two antenna ports is transmitted via one or more antennas on one polarization direction.

8. The method of claim 7, wherein the SSB comprises one or more of:
one or more primary synchronization signals (PSSs);
one or more secondary synchronization signals (SSSs);
a PBCH; or
one or more demodulation reference signals (DMRSs) for the PBCH.

9. The method of claim 7, wherein the pattern comprises: a same PSS, a same PBCH-DMRS, and a same PBCH being transmitted over the two antenna ports and SSS sequences being grouped into pairs, and wherein for each pair of the SSS sequences, a first SSS sequence is transmitted via the first antenna port, and a second SSS sequence is transmitted via the second antenna port.

10. The method of claim 7, wherein the pattern comprises: a same PSS, a same SSS, and a same PBCH being transmitted over the two antenna ports and two orthogonal PBCH-DMRSs being generated with time or frequency domain orthogonal cover code (OCC), wherein the two orthogonal PBCH-DMRSs are transmitted over the two antenna ports, wherein a first PBCH-DMRS of the two orthogonal PBCH-DMRSs is transmitted via the first antenna port, and wherein a second PBCH-DMRS of the two orthogonal PBCH-DMRSs is transmitted via the second antenna port.

11. The method of claim 7, wherein the pattern comprises: a same SSS, a same PBCH-DMRS, and a same PBCH being transmitted over the two antenna ports and PSS sequences being grouped into pairs, wherein for each pair of the PSS sequences, a first PSS sequence is transmitted via the first antenna port, and a second PSS sequence is transmitted via the second antenna port.

12. The method of claim 7, further comprising:
measuring a signal strength of a signal received on at least one receive beam corresponding to one polarization direction; and
subsequent to the signal strength exceeding a threshold, initiating an initial access procedure.

13. A device comprising:
one or more processors, when executing program instructions stored in the device, cause the device to:
transmit, on at least one beam, a synchronization signal (SS)/physical broadcast channel (PBCH) block (SSB) on two antenna ports including a first antenna port and a second antenna port, the transmitting using a pattern for which the first antenna port and the second antenna port of the SSB are associated with polarization directions of antennas or polarization directions in relation to a reference plane, wherein each of the two antenna ports is transmitted via one or more antennas on one polarization direction.

14. The device of claim 13, wherein the SSB comprises one or more of:
one or more primary synchronization signals (PSSs);
one or more secondary synchronization signals (SSSs);
a PBCH; or
one or more demodulation reference signals (DMRSs) for the PBCH.

15. The device of claim 13, wherein the pattern comprises: a same PSS, a same PBCH-DMRS, and a same PBCH being transmitted over the two antenna ports and SSS sequences being grouped into pairs, and wherein for each pair of the SSS sequences, a first SSS sequence is transmitted via the first antenna port and a second SSS sequence is transmitted via the second antenna port.

16. The device of claim 13, wherein the pattern comprises: a same PSS, a same SSS, and a same PBCH being transmitted over the two antenna ports and two orthogonal PBCH-DMRSs are generated with time or frequency domain orthogonal cover code (OCC) or code division multiplexing (CDM), wherein the two orthogonal PBCH-DMRSs are transmitted over the two antenna ports, wherein a first PBCH-DMRS of the two orthogonal PBCH-DMRSs is transmitted via the first antenna port, and wherein a second PBCH-DMRS of the two orthogonal PBCH-DMRSs is transmitted via the second antenna port.

17. The device of claim 13, wherein the pattern comprises: a same SSS, a same PBCH-DMRS, and a same PBCH being transmitted over the two antenna ports and PSS sequences being grouped into pairs, wherein for each pair of the PSS sequences, a first PSS sequence is transmitted via the first antenna port and a second PSS sequence is transmitted via the second antenna port.

18. A device comprising:
one or more processors, when executing program instructions stored in the device, cause the device to:
receive, on at least one beam, at a receiver, a synchronization signal (SS)/physical broadcast channel (PBCH) block (SSB) that has been transmitted on two antenna ports including a first antenna port and a second antenna port using a pattern for which the first antenna port and the second antenna port of the SSB are associated with polarization directions of antennas or polarization directions in relation to a reference plane, wherein each of the two antenna ports is transmitted via one or more antennas on one polarization direction.

19. The device of claim 18, wherein the SSB comprises one or more of:
one or more primary synchronization signals (PSSs);
one or more secondary synchronization signals (SSSs);
a PBCH; or
one or more demodulation reference signals (DMRSs) for the PBCH.

20. The device of claim 18, the one or more processors further cause the device to:
measure a signal strength of a signal received on at least one receive beam corresponding to one polarization direction; and
subsequent to the signal strength exceeding a threshold, initiate an initial access procedure.
